(19) United States
(12) Patent Application Publication
(10) Pub. No.: US 2024/0337763 A1
(43) Pub. Date: Oct. 10, 2024

(54) A method for determining an amount of radiation

(71) Applicant: Turun yliopisto, Turun yliopisto (FI)

(72) Inventors: Mika Lastusaari, Turku (FI); Isabella Norrbo, Turku (FI); Sami Vuori, Paimio (FI)

(21) Appl. No.: 18/292,944

(22) PCT Filed: Jul. 21, 2022
(86) PCT No.: PCT/FI2022/050502

§ 371 Date: Jan. 29, 2024

(30) Foreign Application Priority Data
Jul. 27, 2021 (FI) 20215822

(51) Int. Cl. G01T 1/02

(52) U.S. Cl. CPC G01T 1/02

(57) ABSTRACT

The present invention relates to a method for determining an amount of radiation having a wavelength of 1 zm-10 pm or particle radiation irradiated on a sensor material, the method comprising exposing the sensor material to said radiation for a period of time; subjecting the exposed sensor material to a measurement by a device configured to measure intensity of a colour; measuring the intensity of the colour of reflected, transmitted or detected light; and determining the amount of radiation to which the sensor material has been exposed, based on the measured intensity of the colour of the reflected, transmitted or detected light. The sensor material comprises a material represented by (M′)₈(M″M′″)₆O₂₄(X,X′)₂:M″″.

### FIELD

The present invention relates to a method for determining an amount of radiation having a wavelength of 1 zm-10 pm or particle radiation irradiated on a sensor material. The present invention also relates to a method for detecting and creating a radiation map within a space, to use of such method and further, to a dosimeter.

### BACKGROUND AND OBJECTS

Hackmanite, which is a variety of sodalite material, is a natural mineral having the chemical formula of Na₈Al₆Si₆O₂₄(Cl,S)₂. A synthetic hackmanite-based material can be prepared and these materials can also be called hackmanites. These synthetic materials are described for example in WO 2017/194825 and WO 2017/194834, and can be used for various devices, such as for detecting and indicating the intensity of a radiation (as described in WO 2019/092309) or for determining the amount of radiation (as described in WO 2019/092308). In the method described in WO 2019/092308, the amount of radiation is determined based on an amount of visible light emitted by a sensor material as a result of being subjected to heat treatment and/or to optical stimulation.

It is an aim of the present invention to provide an alternative method of determining the amount of radiation on a subject or within a space, especially a method that can be used for gamma radiation. Suitably, the method is usable also for other electromagnetic radiation and particle radiation. A specific aim of the invention is to provide a method for determining gamma radiation in a manner that is easy to use, and hence to allow manufacturing of a wearable dosimeter or other easily transportable devices for such use. A particular aim is also to provide a passive gamma-detector, i.e. one that does not require electronic devices for the detection as such.

### SUMMARY OF THE INVENTION

The invention is defined by the features of the independent claims. Some specific embodiments are defined in the dependent claims.

According to a first aspect, there is provided a method for determining an amount of radiation having a wavelength of 1 zm-10 pm or particle radiation irradiated on a sensor material, the method comprising
exposing the sensor material to said radiation for a period of time,
subjecting the exposed sensor material to a measurement by a device configured to measure intensity of a colour,
measuring the intensity of the colour of reflected, transmitted or detected light, and
determining the amount of radiation to which the sensor material has been exposed, based on the measured intensity of the colour of the reflected, transmitted or detected light,

wherein the sensor material comprises a material represented by formula (I)

(M′)₈(M′″)₆O₂₄(X,X′)₂:M″″ formula (I)

wherein
M′ represents calcium or a monoatomic cation of an alkali metal selected from Group 1 of the IUPAC periodic table of the elements, or any combination of such cations;
M″ represents a trivalent monoatomic cation of an element selected from Group 13 of the IUPAC periodic table of the elements, or of a transition element selected from any of Groups 3-12 of the IUPAC periodic table of the elements, or any combination of such cations;
M″′ represents a monoatomic cation of an element selected from Group 14 of the IUPAC periodic table of the elements, or of an element selected from any of Groups 13 and 15 of the IUPAC periodic table of the elements, or of Zn, or any combination of such cations;
X represents an anion of an element selected from Group 17 of the IUPAC periodic table of the elements, or any combination of such anions, or wherein X is absent;
X′ represents an anion of one or more elements selected from Group 16 of the IUPAC periodic table of the elements, or any combination of such anions, or wherein X′ is absent; and
M″″ represents a dopant, or wherein M″″ is absent;
   with the proviso that at least one of X and X′ is present.

According to a second aspect, there is provided a method for creating a radiation map within a space, comprising
arranging sensor material comprising a material represented by formula (I), on at least two different locations within the space,
using the method defined above for determining an amount of radiation irradiated on the sensor materials, and
providing the radiation map within the space, based on the determined amounts of radiation on the sensor materials and their locations.

According to a third aspect, there is provided a use of the method for determining an amount of radiation having a wavelength of 1 zm-10 pm or particle radiation irradiated on a sensor material, for imaging with gamma radiation.

According to a fourth aspect, there is provided dosimeter for gamma irradiation, comprising a material represented by formula (I).

### BRIEF DESCRIPTION OF THE DRAWINGS

FIG. 1 illustrates colour intensity of reflected light from some samples according to an embodiment.

FIGS. 2-6 illustrate reflectance of light of some samples according to an embodiment.

FIGS. 7 and 8 illustrate integrals of the reflectance of light of the samples used for FIGS. 2-6.

FIGS. 9-15 illustrate CIE L*a*b coordinates for samples used for FIGS. 2-6.

FIGS. 16 and 17 illustrate some samples after gamma radiation.

### DETAILED DESCRIPTION

The present description relates to a method for determining an amount of radiation having a wavelength of 1 zm-10 pm or particle radiation irradiated on a sensor material, the method comprising
exposing the sensor material to said radiation for a period of time,
subjecting the exposed sensor material to a measurement by a device configured to measure intensity of a colour,
measuring the intensity of the colour of reflected, transmitted or detected light, and
determining the amount of radiation to which the sensor material has been exposed, based on the measured intensity of the colour of the reflected, transmitted or detected light,

wherein the sensor material comprises a material represented by formula (I)

(M′)₈(M″M″′)₆O₂₄(X,X′)₂:M″″ formula (I)

wherein
M′ represents calcium or a monoatomic cation of an alkali metal selected from Group 1 of the IUPAC periodic table of the elements, or any combination of such cations;
M″ represents a trivalent monoatomic cation of an element selected from Group 13 of the IUPAC periodic table of the elements, or of a transition element selected from any of Groups 3-12 of the IUPAC periodic table of the elements, or any combination of such cations;
M″′ represents a monoatomic cation of an element selected from Group 14 of the IUPAC periodic table of the elements, or of an element selected from any of Groups 13 and 15 of the IUPAC periodic table of the elements, or of Zn, or any combination of such cations;
X represents an anion of an element selected from Group 17 of the IUPAC periodic table of the elements, or any combination of such anions, or wherein X is absent;
X′ represents an anion of one or more elements selected from Group 16 of the IUPAC periodic table of the elements, or any combination of such anions, or wherein X′ is absent; and
M″″ represents a dopant, or wherein M″″ is absent;
   with the proviso that at least one of X and X′ is present.

In the present method, the amount of radiation is thus determined based on the intensity of colour of the sensor material exposed to radiation, either directly or indirectly. The present method may be used for monitoring various radiation sources, for example to ensure the radiation is not scattered to areas it should not be directed to, or to use for monitoring the amount of radiation a person is receiving within a given time frame. The present method also makes it possible to manufacture a passive gamma radiation detector, where electronic devices are only needed for reading the detector after detection, but not during the detection as such. Furthermore, the present method may be used in tenebrescence imaging for dense objects as well as for monitoring food irradiation, sterilization of food or medical packaging or devices, or similar.

According to an embodiment, determining the amount of radiation to which the sensor material has been exposed is carried out by comparing the measured intensity of the colour of the reflected, transmitted or detected light to a database comprising measured intensity values and corresponding radiation values. The database may comprise at least one of a lookup table and a graph.

In such a database, the intensity values and corresponding radiation values are given, and are based on measurements carried out in controlled conditions, i.e. where the amount of radiation used is known. The database can, in addition to being a lookup table, can also be any other suitable form of data structure. The database may be used automatically (i.e. the process may be computerised), or it may be used manually. When comparing the measured intensity to the information in the database, the amount of radiation to which the material has been subjected to can be determined.

The radiation which amount can be measured with the present method includes radiation having a wavelength of 1 zm-10 pm and particle radiation. According to an embodiment, the radiation is thus electromagnetic radiation. According to another embodiment, the radiation is gamma radiation. The radiation may also be particle radiation, such as alpha radiation, beta radiation, proton radiation, neutron radiation and/or positron radiation.

The radiation may thus have a wavelength from 1 zm (zeptometre, i.e. 1.0×10⁻²¹ m), 500 zm, 1 am (attometre, i.e. 1.0×10⁻¹⁸ m), 500 am, 1 fm (femtometre, i.e. 1.0×10⁻¹⁵ m), 500 fm, or 1 pm (picometre, i.e. 1.0×10⁻¹² m) up to 500 zm, 1 fm, 500 fm, 1 pm, or 10 pm. For example, the wavelength range of gamma radiation is 1 zm-10 pm.

The radiations which intensity can be determined with the above method are used in various applications, for example in medical appliances, diagnostics, medical treatments, cleaning, food manufacturing, disinfection, etc.

According to an aspect, there is also provided dosimeter for gamma irradiation, comprising a material represented by formula (I). This dosimeter is a passive dosimeter, which is thus easy to make and light weight to carry (i.e. can be made for example to a form that can be placed in a pocket). Similarly, it is possible to manufacture dosimeters for particle radiation.

The energy of the radiation which amount can be determined with the present method is for example 1 keV-1000 TeV, such as 40 keV-2 MeV. The upper limit may even be up to 2000 TeV.

In the present method, the sensor material is exposed to said radiation for a period of time. This period of time the sensor material is exposed to radiation may be up to ten years. For example, this period of time may be up to 5, 10, 15, 30 or 45 minutes, 1, 5, 10, 15 or 20 hours, 1, 5, 10, 15, 20, 25 or 30 days or 1, 5 or 10 years. The time is typically dependent on the application the method is used for, i.e. is it used for example for monitoring the amount of radiation a person is submitted to or to provide a radiation map (as will be explained in more detail below).

The exposed sensor material is subjected to a measurement by a device configured to measure intensity of a colour. Such device may for example be selected from a group consisting of a colour spectrophotometer, a photodetector (which may also be called a photosensor) and a camera. The camera may be for example linked to a computer program or an app, which is capable of quantifying the intensity of the colour. Thus, depending on the device configured to measure intensity of the colour, it measures the intensity of the colour of reflected, transmitted or detected light.

Without wishing to be bound by a theory, the present inventors believe that the colour of the light that is reflected, transmitted or detected depends on the radiation to which the material has been subjected, i.e. the sensor material that has been irradiated with gamma radiation has a different colour from the same sensor material irradiated with UV-radiation. The present method may thus be used also to determine the type of radiation the material has been subjected to. Alternatively, it is also possible to place different wavelength filters in front of different locations of the material, such that each location only received a pre-determined wavelength of radiation.

The measurement of the intensity of the colour of the light is carried out preferably without the sensor material being exposed to visible light before the measurement, or at least for only a minimal period of time (such as a few minutes or up to 30 minutes). Should it not be possible to immediately measure the intensity of the colour, the sensor material is most preferably stored in a light-tight container, and at room temperature.

The material of formula (I) is an optically active material that is configured to be able to retain radiation exposed thereon, i.e. the material is able to trap therein the radiation that it is exposed to.

In one embodiment, M′ represents a monoatomic cation of an alkali metal selected from a group consisting of Na, Li, K, Rb, Cs, and Fr, or any combination of such cations. In another embodiment, M′ represents a monoatomic cation of an alkali metal selected from Group 1 of the IUPAC periodic table of the elements, or any combination of such cations, with the proviso that M′ does not represent the monoatomic cation of Na alone. According to an embodiment, M′ represents a combination of at least two monoatomic cations of different alkali metals selected from a group consisting of Li, Na, K, Rb, Cs, and Fr. According to another embodiment, M′ represents an alkaline earth element.

In one embodiment, M′ represents a combination of at least two monoatomic cations of different alkali metals selected from Group 1 of the IUPAC periodic table of the elements, or alkaline earth elements. When alkaline earth elements are present, the stoichiometric number in M′₈ adjusts to keep the overall charge of 8+ induced by the M′ atoms. In one embodiment, M′ represents a combination of at least two monoatomic cations of different alkali metals selected from Group 1 of the IUPAC periodic table of the elements, wherein the combination comprises at most 98 mol-%, at most 95 mol-%, at most 90 mol-%, at most 85 mol-%, at most 80 mol-%, at most 70 mol-%, at most 60 mol-%, at most 50 mol-%, at most 40 mol-% of the monoatomic cation of Na, or at most 30 mol- % of the monoatomic cation of Na, or at most 20 mol-% of the monoatomic cation of Na.

In a yet further embodiment, M′ represents a monoatomic cation of Li. In one embodiment, M′ represents a monoatomic cation of K. In one embodiment, M′ represents a monoatomic cation of Rb. In one embodiment, M′ represents a monoatomic cation of Cs. In one embodiment, M′ represents a monoatomic cation of Fr.

In one embodiment, M″ represents a trivalent monoatomic cation of a metal selected from a group consisting of Al and Ga, or a combination of such cations. In one embodiment, M″ represents a trivalent monoatomic cation of B. In one embodiment, M″ represents a trivalent monoatomic cation of a transition element selected from Period 4 of the IUPAC periodic table of the elements, or any combination of such cations. In one embodiment, M″ represents a trivalent monoatomic cation of an element selected from a group consisting of Cr, Mn, Fe, Co, Ni, and Zn, or any combination of such cations.

In one embodiment, M″′ represents a monoatomic cation of an element selected from a group consisting of Si, Ge, Al, Ga, N, P, and As, or any combination of such cations. In one embodiment, M″′ represents a monoatomic cation of an element selected from a group consisting of Si and Ge, or a combination of such cations. In one embodiment, M″′ represents a monoatomic cation of an element selected from a group consisting of Al, Ga, N, P, and As, or any combination of such cations. In one embodiment, M″′ represents a monoatomic cation of an element selected from a group consisting of Al and Ga, or a combination of such cations. In one embodiment, M″′ represents a monoatomic cation of an element selected from a group consisting of N, P, and As, or any combination of such cations. In one embodiment, M″′ represents a monoatomic cation of Zn.

In one embodiment, X represents an anion of an element selected from a group consisting of F, Cl, Br, I, and At, or any combination of such anions. In one embodiment, X represents an anion of an element selected from a group consisting of F, Cl, Br, and I, or any combination of such anions. In one embodiment, X is absent.

In one embodiment, X′ represents an anion of an element selected from a group consisting of O, S, Se, and Te, or any combination of such anions. In one embodiment, X′ represents an anion of one or more elements selected from a group consisting of O, S, Se, and Te, or any combination of such anions. In one embodiment, X′ represents a monoatomic or a polyatomic anion of one or more elements selected from a group consisting of O, S, Se, and Te, or any combination of such anions. In one embodiment, X′ represents an anion of S. In an embodiment, X′ is (SO₄)²⁻ or other sulphur oxyanion. In yet another embodiment X′ is absent.

The proviso that at least one of X and X′ is present should in this specification, unless otherwise stated, be understood such that either X or X′ is present, or such that both X and X′ are present.

In one embodiment, the material is doped with at least one transition metal ion.

M″″ represents a dopant or it is absent. According to an embodiment, M″″ represents a dopant cation of an element selected from rare earth metals of the IUPAC periodic table of the elements, or from transition metals of the IUPAC periodic table of the elements, or of Ca, Ba, Sr, Tl, Pb, or Bi, or any combination of such cations. The dopant may be any element or combination of elements. The dopant may for example be an element that does not take part in the functioning of the material.

In one embodiment, the material is represented by formula (I), wherein M″″ represents a cation of an element selected from transition metals of the IUPAC periodic table of the elements, or of Ca, Ba, Sr, Tl, Pb, or Bi, or any combination of such cations. In one embodiment, M″″ represents a cation of an element selected from transition metals of the f-block of the IUPAC periodic table of the elements. In one embodiment, M″″ represents a cation of an element selected from transition metals of the d-block of the IUPAC periodic table of the elements. In one embodiment, M″″ represents a cation of an element selected from a group consisting of Ti, V, Cr, Mn, Fe, Co, Ni, Cu, Ag, W, and Zn, or any combination of such cations. In one embodiment, M″″ represents a cation of Ti. In one embodiment, M″″ represents a dopant cation of an element selected from rare earth metals of the IUPAC periodic table of the elements. In one embodiment, M″″ represents a cation of an element selected from a group consisting of Yb, Er, Tb, and Eu, or any combination of such cations. In one embodiment, M″″ represents a combination of two or more dopant cations.

In one embodiment, the material is represented by formula (I), wherein M″″ is absent. In this embodiment, the material is not doped. In one embodiment, the material represented by the formula (I) comprises M″″ in an amount of 0.001-10 mol-%, or 0.001-5 mol-%, or 0.1-5 mol-% based on the total amount of the material.

According to a further embodiment, the material represented by formula (I) comprises residuals. These residuals originate from the manufacturing process of the material, and may be present in an amount of up to 1 mol-% or even more, such as up to 10 mol-%.

In one embodiment, the material represented by formula (I) is selected from a group consisting of:
(LiₓNa_{1-x-y-z}K_{y}Rb_{z})₈(Al,Ga)₆Si₆O₂₄(Cl,S)₂:Ti,
(LiₓNa_{1-x-y-z}K_{y}Rb_{z})₈(Al,Cr)₆Si₆O₂₄(Cl,S)₂:Ti,
(LiₓNa_{1-x-y-z}K_{y}Rb_{z})₈(Al,Mn)₆Si₆O₂₄(Cl,S)₂:Ti,
(LiₓNa_{1-x-y-z}K_{y}Rb_{z})₈(Al,Fe)₆Si₆O₂₄(Cl,S)₂:Ti,
(LiₓNa_{1-x-y-z}K_{y}Rb_{z})₈(Al,Co)₆Si₆O₂₄(Cl,S)₂:Ti,
(LiₓNa_{1-x-y-z}K_{y}Rb_{z})₈(Al,Ni)₆Si₆O₂₄(Cl,S)₂:Ti,
(LiₓNa_{1-x-y-z}K_{y}Rb_{z})₈(Al,Cu)₆Si₆O₂₄(Cl,S)₂:Ti,
(LiₓNa_{1-x-y-z}K_{y}Rb_{z})₈(Al,B)₆Si₆O₂₄(Cl,S)₂:Ti,
(LiₓNa_{1-x-y-z}K_{y}Rb_{z})₈Mn₆Si₆O₂₄(Cl,S)₂:Ti,
(LiₓNa_{1-x-y-z}K_{y}Rb_{z})₈Cr₆Si₆O₂₄(Cl,S)₂:Ti,
(LiₓNa_{1-x-y-z}K_{y}Rb_{z})₈Fe₆Si₆O₂₄(Cl,S)₂:Ti,
(LiₓNa_{1-x-y-z}K_{y}Rb_{z})₈Co₆Si₆O₂₄(Cl,S)₂:Ti,
(LiₓNa_{1-x-y-z}K_{y}Rb_{z})₈Ni₆Si₆O₂₄(Cl,S)₂:Ti,
(LiₓNa_{1-x-y-z}K_{y}Rb_{z})₈Cu₆Si₆O₂₄(Cl,S)₂:Ti,
(LiₓNa_{1-x-y-z}K_{y}Rb_{z})₈B₆Si₆O₂₄(Cl,S)₂:Ti,
(LiₓNa_{1-x-y-z}K_{y}Rb_{z})₈Ga₆Si₆O₂₄(Cl,S)₂:Ti,
(LiₓNa_{1-x-y-z}K_{y}Rb_{z})₈Al₆Si₆O₂₄(Cl,S)₂:Ti,
(LiₓNa_{1-x-y-z}K_{y}Rb_{z})₈Al₆(Si,Zn)₆O₂₄(Cl,S)₂:Ti,
(LiₓNa_{1-x-y-z}K_{y}Rb_{z})₈Al₆(Si,Ge)₆O₂₄(Cl,S)₂:Ti,
(LiₓNa_{1-x-y-z}K_{y}Rb_{z})₈Al₆Zn₆O₂₄(Cl,S)₂:Ti,
(LiₓNa_{1-x-y-z}K_{y}Rb_{z})₈Al₆Ge₆O₂₄(Cl,S)₂:Ti,
(LiₓNa_{1-x-y-z}K_{y}Rb_{z})₈Al₆(Ga,Si,N)₆O₂₄(Cl,S)₂:Ti,
(LiₓNa_{1-x-y-z}K_{y}Rb_{z})₈Al₆(Ga,Si,As)₆O₂₄(Cl,S)₂:Ti,
(LiₓNa_{1-x-y-z}K_{y}Rb_{z})₈Al₆(Ga,N)₆O₂₄(Cl,S)₂:Ti,
(LiₓNa_{1-x-y-z}K_{y}Rb_{z})₈Al₆(Ga,As)₆O₂₄(Cl,S)₂:Ti,
(LiₓNa_{1-x-y-z}K_{y}Rb_{z})₈(Al,Ga)₆Ge₆O₂₄(Cl,S)₂:Ti,
(LiₓNa_{1-x-y-z}K_{y}Rb_{z})₈(Al,Cr)₆Ge₆O₂₄(Cl,S)₂:Ti,
(LiₓNa_{1-x-y-z}K_{y}Rb_{z})₈(Al,Mn)₆Ge₆O₂₄(Cl,S)₂:Ti,
(LiₓNa_{1-x-y-z}K_{y}Rb_{z})₈(Al,Fe)₆Ge₆O₂₄(Cl,S)₂:Ti,
(LiₓNa_{1-x-y-z}K_{y}Rb_{z})₈(Al,Co)₆Ge₆O₂₄(Cl,S)₂:Ti,
(LiₓNa_{1-x-y-z}K_{y}Rb_{z})₈(Al,Ni)₆Ge₆O₂₄(Cl,S)₂:Ti,
(LiₓNa_{1-x-y-z}K_{y}Rb_{z})₈(Al,Cu)₆Ge₆O₂₄(Cl,S)₂:Ti,
(LiₓNa_{1-x-y-z}K_{y}Rb_{z})₈(Al,B)₆Ge₆O₂₄(Cl,S)₂:Ti,
(LiₓNa_{1-x-y-z}K_{y}Rb_{z})₈Mn₆Ge₆O₂₄(Cl,S)₂:Ti,
(LiₓNa_{1-x-y-z}K_{y}Rb_{z})₈Cr₆Ge₆O₂₄(Cl,S)₂:Ti,
(LiₓNa_{1-x-y-z}K_{y}Rb_{z})₈Fe₆Ge₆O₂₄(Cl,S)₂:Ti,
(LiₓNa_{1-x-y-z}K_{y}Rb_{z})₈Co₆Ge₆O₂₄(Cl,S)₂:Ti,
(LiₓNa_{1-x-y-z}K_{y}Rb_{z})₈Ni₆Ge₆O₂₄(Cl,S)₂:Ti,
(LiₓNa_{1-x-y-z}K_{y}Rb_{z})₈Cu₆Ge₆O₂₄(Cl,S)₂:Ti,
(LiₓNa_{1-x-y-z}K_{y}Rb_{z})₈B₆Ge₆O₂₄(Cl,S)₂:Ti, and
(LiₓNa_{1-x-y-z}K_{y}Rb_{z})₈Ga₆Ge₆O₂₄(Cl,S)₂:Ti,
   wherein

$$x + y + z \leq 1 , and$$

$$x \geq 0 , y \geq 0 , z \geq 0 .$$

Some further suitable materials are LiNa₇Al₆Si₆O₂₄(Br,S)₂:Sr, where the amount of Sr varies from 3 to 6 mol-%. The material may also comprise Cu, for example in the amount of 1 mol-%. Some suitable materials represented by formula (I) can be selected from a group consisting of:
(LiₓNa_{1-x-y-z}K_{y}Rb_{z})₈(Al,Ga)₆Si₆O₂₄(Br,S)₂:Sr,
(LiₓNa_{1-x-y-z}K_{y}Rb_{z})₈(Al,Cr)₆Si₆O₂₄(Br,S)₂:Sr,
(LiₓNa_{1-x-y-z}K_{y}Rb_{z})₈(Al,Mn)₆Si₆O₂₄(Br,S)₂:Sr,
(LiₓNa_{1-x-y-z}K_{y}Rb_{z})₈(Al,Fe)₆Si₆O₂₄(Br,S)₂:Sr,
(LiₓNa_{1-x-y-z}K_{y}Rb_{z})₈(Al,Co)₆Si₆O₂₄(Br,S)₂:Sr,
(LiₓNa_{1-x-y-z}K_{y}Rb_{z})₈(Al,Ni)₆Si₆O₂₄(Br,S)₂:Sr,
(LiₓNa_{1-x-y-z}K_{y}Rb_{z})₈(Al,Cu)₆Si₆O₂₄(Br,S)₂:Sr,
(LiₓNa_{1-x-y-z}K_{y}Rb_{z})₈(Al,B)₆Si₆O₂₄(Br,S)₂:Sr,
(LiₓNa_{1-x-y-z}K_{y}Rb_{z})₈Mn₆Si₆O₂₄(Br,S)₂:Sr,
(LiₓNa_{1-x-y-z}K_{y}Rb_{z})₈Cr₆Si₆O₂₄(Br,S)₂:Sr,
(LiₓNa_{1-x-y-z}K_{y}Rb_{z})₈Fe₆Si₆O₂₄(Br,S)₂:Sr,
(LiₓNa_{1-x-y-z}K_{y}Rb_{z})₈Co₆Si₆O₂₄(Br,S)₂:Sr,
(LiₓNa_{1-x-y-z}K_{y}Rb_{z})₈Ni₆Si₆O₂₄(Br,S)₂:Sr,
(LiₓNa_{1-x-y-z}K_{y}Rb_{z})₈Cu₆Si₆O₂₄(Br,S)₂:Sr,
(LiₓNa_{1-x-y-z}K_{y}Rb_{z})₈B₆Si₆O₂₄(Br,S)₂:Sr,
(LiₓNa_{1-x-y-z}K_{y}Rb_{z})₈Ga₆Si₆O₂₄(Br,S)₂:Sr,
(LiₓNa_{1-x-y-z}K_{y}Rb_{z})₈Al₆Si₆O₂₄(Br,S)₂:Sr,
(LiₓNa_{1-x-y-z}K_{y}Rb_{z})₈Al₆(Si,Zn)₆O₂₄(Br,S)₂:Sr,
(LiₓNa_{1-x-y-z}K_{y}Rb_{z})₈Al₆(Si,Ge)₆O₂₄(Br,S)₂:Sr,
(LiₓNa_{1-x-y-z}K_{y}Rb_{z})₈Al₆Zn₆O₂₄(Br,S)₂:Sr,
(LiₓNa_{1-x-y-z}K_{y}Rb_{z})₈Al₆Ge₆O₂₄(Br,S)₂:Sr,
(LiₓNa_{1-x-y-z}K_{y}Rb_{z})₈Al₆(Ga,Si,N)₆O₂₄(Br,S)₂:Sr,
(LiₓNa_{1-x-y-z}K_{y}Rb_{z})₈Al₆(Ga,Si,As)₆O₂₄(Br,S)₂:Sr,
(LiₓNa_{1-x-y-z}K_{y}Rb_{z})₈Al₆(Ga,N)₆O₂₄(Br,S)₂:Sr,
(LiₓNa_{1-x-y-z}K_{y}Rb_{z})₈Al₆(Ga,As)₆O₂₄(Br,S)₂:Sr,
(LiₓNa_{1-x-y-z}K_{y}Rb_{z})₈(Al,Ga)₆Ge₆O₂₄(Br,S)₂:Sr,
(LiₓNa_{1-x-y-z}K_{y}Rb_{z})₈(Al,Cr)₆Ge₆O₂₄(Br,S)₂:Sr,
(LiₓNa_{1-x-y-z}K_{y}Rb_{z})₈(Al,Mn)₆Ge₆O₂₄(Br,S)₂:Sr,
(LiₓNa_{1-x-y-z}K_{y}Rb_{z})₈(Al,Fe)₆Ge₆O₂₄(Br,S)₂:Sr,
(LiₓNa_{1-x-y-z}K_{y}Rb_{z})₈(Al,Co)₆Ge₆O₂₄(Br,S)₂:Sr,
(LiₓNa_{1-x-y-z}K_{y}Rb_{z})₈(Al,Ni)₆Ge₆O₂₄(Br,S)₂:Sr,
(LiₓNa_{1-x-y-z}K_{y}Rb_{z})₈(Al,Cu)₆Ge₆O₂₄(Br,S)₂:Sr,
(LiₓNa_{1-x-y-z}K_{y}Rb_{z})₈(Al,B)₆Ge₆O₂₄(Br,S)₂:Sr,
(LiₓNa_{1-x-y-z}K_{y}Rb_{z})₈Mn₆Ge₆O₂₄(Br,S)₂:Sr,
(LiₓNa_{1-x-y-z}K_{y}Rb_{z})₈Cr₆Ge₆O₂₄(Br,S)₂:Sr,
(LiₓNa_{1-x-y-z}K_{y}Rb_{z})₈Fe₆Ge₆O₂₄(Br,S)₂:Sr,
(LiₓNa_{1-x-y-z}K_{y}Rb_{z})₈Co₆Ge₆O₂₄(Br,S)₂:Sr,
(LiₓNa_{1-x-y-z}K_{y}Rb_{z})₈Ni₆Ge₆O₂₄(Br,S)₂:Sr,
(LiₓNa_{1-x-y-z}K_{y}Rb_{z})₈Cu₆Ge₆O₂₄(Br,S)₂:Sr,
(LiₓNa_{1-x-y-z}K_{y}Rb_{z})₈B₆Ge₆O₂₄(Br,S)₂:Sr,
(LiₓNa_{1-x-y-z}K_{y}Rb_{z})₈Ga₆Ge₆O₂₄(Br,S)₂:Sr,
(LiₓNa_{1-x-y-z}K_{y}Rb_{z})₈(Al,Ga)₆Si₆O₂₄(Br,S)₂:Sr,Cu,
(LiₓNa_{1-x-y-z}K_{y}Rb_{z})₈(Al,Cr)₆Si₆O₂₄(Br,S)₂:Sr,Cu,
(LiₓNa_{1-x-y-z}K_{y}Rb_{z})₈(Al,Mn)₆Si₆O₂₄(Br,S)₂:Sr,Cu,
(LiₓNa_{1-x-y-z}K_{y}Rb_{z})₈(Al,Fe)₆Si₆O₂₄(Br,S)₂:Sr,Cu,
(LiₓNa_{1-x-y-z}K_{y}Rb_{z})₈(Al,Co)₆Si₆O₂₄(Br,S)₂:Sr,Cu,
(LiₓNa_{1-x-y-z}K_{y}Rb_{z})₈(Al,Ni)₆Si₆O₂₄(Br,S)₂:Sr,Cu,
(LiₓNa_{1-x-y-z}K_{y}Rb_{z})₈(Al,Cu)₆Si₆O₂₄(Br,S)₂:Sr,Cu,
(LiₓNa_{1-x-y-z}K_{y}Rb_{z})₈(Al,B)₆Si₆O₂₄(Br,S)₂:Sr,Cu,
(LiₓNa_{1-x-y-z}K_{y}Rb_{z})₈Mn₆Si₆O₂₄(Br,S)₂:Sr,Cu,
(LiₓNa_{1-x-y-z}K_{y}Rb_{z})₈Cr₆Si₆O₂₄(Br,S)₂:Sr,Cu,
(LiₓNa_{1-x-y-z}K_{y}Rb_{z})₈Fe₆Si₆O₂₄(Br,S)₂:Sr,Cu,
(LiₓNa_{1-x-y-z}K_{y}Rb_{z})₈Co₆Si₆O₂₄(Br,S)₂:Sr,Cu,
(LiₓNa_{1-x-y-z}K_{y}Rb_{z})₈Ni₆Si₆O₂₄(Br,S)₂:Sr,Cu,
(LiₓNa_{1-x-y-z}K_{y}Rb_{z})₈Cu₆Si₆O₂₄(Br,S)₂:Sr,Cu,
(LiₓNa_{1-x-y-z}K_{y}Rb_{z})₈B₆Si₆O₂₄(Br,S)₂:Sr,Cu,
(LiₓNa_{1-x-y-z}K_{y}Rb_{z})₈Ga₆Si₆O₂₄(Br,S)₂:Sr,Cu,
(LiₓNa_{1-x-y-z}K_{y}Rb_{z})₈Al₆Si₆O₂₄(Br,S)₂:Sr,Cu,
(LiₓNa_{1-x-y-z}K_{y}Rb_{z})₈Al₆(Si,Zn)₆O₂₄(Br,S)₂:Sr,Cu,
(LiₓNa_{1-x-y-z}K_{y}Rb_{z})₈Al₆(Si,Ge)₆O₂₄(Br,S)₂:Sr,Cu,
(LiₓNa_{1-x-y-z}K_{y}Rb_{z})₈Al₆Zn₆O₂₄(Br,S)₂:Sr,Cu,
(LiₓNa_{1-x-y-z}K_{y}Rb_{z})₈Al₆Ge₆O₂₄(Br,S)₂:Sr,Cu,
(LiₓNa_{1-x-y-z}K_{y}Rb_{z})₈Al₆(Ga,Si,N)₆O₂₄(Br,S)₂:Sr,Cu,
(LiₓNa_{1-x-y-z}K_{y}Rb_{z})₈Al₆(Ga,Si,As)₆O₂₄(Br,S)₂:Sr,Cu,
(LiₓNa_{1-x-y-z}K_{y}Rb_{z})₈Al₆(Ga,N)₆O₂₄(Br,S)₂:Sr,Cu,
(LiₓNa_{1-x-y-z}K_{y}Rb_{z})₈Al₆(Ga,As)₆O₂₄(Br,S)₂:Sr,Cu,
(LiₓNa_{1-x-y-z}K_{y}Rb_{z})₈(Al,Ga)₆Ge₆O₂₄(Br,S)₂:Sr,Cu,
(LiₓNa_{1-x-y-z}K_{y}Rb_{z})₈(Al,Cr)₆Ge₆O₂₄(Br,S)₂:Sr,Cu,
(LiₓNa_{1-x-y-z}K_{y}Rb_{z})₈(Al,Mn)₆Ge₆O₂₄(Br,S)₂:Sr,Cu,
(LiₓNa_{1-x-y-z}K_{y}Rb_{z})₈(Al,Fe)₆Ge₆O₂₄(Br,S)₂:Sr,Cu,
(LiₓNa_{1-x-y-z}K_{y}Rb_{z})₈(Al,Co)₆Ge₆O₂₄(Br,S)₂:Sr,Cu,
(LiₓNa_{1-x-y-z}K_{y}Rb_{z})₈(Al,Ni)₆Ge₆O₂₄(Br,S)₂:Sr,Cu,
(LiₓNa_{1-x-y-z}K_{y}Rb_{z})₈(Al,Cu)₆Ge₆O₂₄(Br,S)₂:Sr,Cu,
(LiₓNa_{1-x-y-z}K_{y}Rb_{z})₈(Al,B)₆Ge₆O₂₄(Br,S)₂:Sr,Cu,
(LiₓNa_{1-x-y-z}K_{y}Rb_{z})₈Mn₆Ge₆O₂₄(Br,S)₂:Sr,Cu,
(LiₓNa_{1-x-y-z}K_{y}Rb_{z})₈Cr₆Ge₆O₂₄(Br,S)₂:Sr,Cu,
(LiₓNa_{1-x-y-z}K_{y}Rb_{z})₈Fe₆Ge₆O₂₄(Br,S)₂:Sr,Cu,
(LiₓNa_{1-x-y-z}K_{y}Rb_{z})₈Co₆Ge₆O₂₄(Br,S)₂:Sr,Cu,
(LiₓNa_{1-x-y-z}K_{y}Rb_{z})₈Ni₆Ge₆O₂₄(Br,S)₂:Sr,Cu,
(LiₓNa_{1-x-y-z}K_{y}Rb_{z})₈Cu₆Ge₆O₂₄(Br,S)₂:Sr,Cu,
(LiₓNa_{1-x-y-z}K_{y}Rb_{z})₈B₆Ge₆O₂₄(Br,S)₂:Sr,Cu, and
(LiₓNa_{1-x-y-z}K_{y}Rb_{z})₈Ga₆Ge₆O₂₄(Br,S)₂:Sr,Cu,
   wherein

$$x + y + z \leq 1 , and$$

$$x \geq 0 , y \geq 0 , z \geq 0 .$$

The material may be synthesized by a reaction according to Norrbo et al. (Norrbo, I.; Gluchowski, P.; Paturi, P.; Sinkkonen, J.; Lastusaari, M., Persistent Luminescence of Tenebrescent Na₈Al₆Si₆O₂₄ (Cl,S)₂: Multifunctional Optical Markers. Inorg. Chem. 2015, 54, 7717-7724), which reference is based on Armstrong & Weller (Armstrong, J.A.; Weller, J.A. Structural Observation of Photochromism. Chem. Commun. 2006, 1094-1096). As an example, stoichiometric amounts of Zeolite A and Na₂SO₄ as well as LiCl, NaCl, KCl and/or RbCl can be used as the starting materials. At least one dopant may be added as an oxide, such as TiO₂, a chloride, a sulfide, a bromide, or a nitrate. The material can be prepared as follows: Zeolite A may first be dried at 500° C. for 1 h. The initial mixture may then be heated at 850° C. in air for e.g. 2 h, 5 h, 12 h, 24 h, 36 h, 48 h, or 72 h. The product may then be freely cooled down to room temperature and ground. Finally, the product may be re-heated at 850° C. for 2 h under a flowing 12% H₂+88% N₂ atmosphere. If needed, the as-prepared materials may be washed with water to remove any excess LiCl/NaCl/KCl/RbCl impurities. The purity can be verified with an X-ray powder diffraction measurement.

The material is prepared in powder form, and is typically also used in powder form. The particle size in the powder is typically about 5-10 μm, as measured by transmission electron microscopy, the area was determined from the pictures with a watershed segmentation algorithm in the ImageJ program.

According to an alternative embodiment, the material treated has formula (II)

(M′)₈(M″M′″)₆O₂₄(X,S)₂:M″″ formula (II)

wherein
M′ represents a monoatomic cation of an alkali metal selected from Group 1 of the IUPAC periodic table of the elements, or any combination of such cations;
M″ represents a trivalent monoatomic cation of an element selected from Group 13 of the IUPAC periodic table of the elements, or of a transition element selected from any of Groups 3-12 of the IUPAC periodic table of the elements, or any combination of such cations;
M″′ represents a monoatomic cation of an element selected from Group 14 of the IUPAC periodic table of the elements, or any combination of such cations;
X represents an anion of an element selected from Group 16 of the IUPAC periodic table of the elements, or from Group 17 of the IUPAC periodic table of the elements, or any combination of such anions; and
M″″ represents a dopant cation of an element selected from rare earth metals of the IUPAC periodic table of the elements, or from transition metals of the IUPAC periodic table of the elements, or any combination of such cations, or wherein M″″ is absent.

The various embodiments and options for the different constituents of the material according to formula (I) listed above apply mutatis mutandis to materials according to formula (II).

The material of the present description is typically non-toxic and non-expensive and also has the benefit of being reusable and recyclable.

The method described above may also comprise, at its beginning, arranging the sensor material in a polymer matrix.

According to one embodiment, the material can be arranged in a polymer matrix by using tape casting, also known as knife coating or doctor blading. Tape casting is a process where a thin sheet of ceramic or metal particle suspension fluid is cast on a substrate. The fluid may contain volatile nonaqueous solvents, a dispersant, (a) binder(s) and the dry matter, i.e. the material having formula (I). The process may comprise preparing the suspension and applying it onto a surface of a substrate. The binder may create a polymer network around the dry matter particles, while the plasticizer may function as a softening agent for the binder. When combining these substances, the tape may become resistant against cracking and flaking off when bent. The dispersant may be used to de-aggregate the particles and homogenize the suspension.

Thus, according to one embodiment the material is arranged in a polymer matrix by mixing the material with the tape casting components. Any suitable and typical tape casting components can be used, as known in the art. According to one embodiment, the tape casting components comprise ethanol Aa, ethyl methyl ketone, triton X-100, benzyl butyl phthalate and polyvinyl butyral.

The polymer matrix, i.e. tape-casting polymer, can comprise one or several different polymers. Any polymer capable to act as an energy converter, i.e. capable to be excited by the optically stimulated luminescence emission, can be used. According to one embodiment, the polymer can be benzyl butyl phthalate or polyvinyl butyral or any combination thereof.

The material, tape-casted in a polymer matrix, thus forms an image detector that can be used in imaging, computed tomography (CT) imaging and other types of imaging. The imaging techniques may use plates or detectors, or a combination of plates and detectors. The detectors may be for example gamma detectors. The material according to formula (I) may be attached to a surface for example as a coating or a film. The substrate of the plate or detector may comprise or consist of glass or polymer. The substrate may comprise or consist of a glass layer or a polymer layer. The substrate may comprise (a) further layer(s). The substrate may also or alternatively comprise an attachment layer, such as a printing paper, and/or a base layer, such as a cardboard layer, or any other layer(s) where desired or needed. The image detector may comprise further layers and/or components. The image detector has the added utility of enabling the use of the material represented by formula (I) as a detector material for imaging purposes. The image detector has a further added utility of making use of an optically active material being non-toxic and non-expensive compared to currently used materials such as Ba(F,Cl,Br,I)₂:Eu and CsI:Ti. The image detector has still an added utility of being reusable and recyclable. Further, the image detector can be used for point-of-care analysis without the need of complicated analysis systems.

The present description further relates to a device, wherein the device comprises a material according to one or more embodiments described in this specification. In one embodiment, the device is a gamma radiation sensor, a gamma radiation detector, a gamma radiation indicator, a gamma radiation dose indicator, a particle radiation sensor, a particle radiation detector, a particle radiation indicator or a particle radiation dose indicator.

According to a further aspect, there is thus provided a use of the method for determining an amount of radiation having a wavelength of 1 zm-10 pm or particle radiation irradiated on a sensor material, for imaging with gamma radiation.

In one embodiment, the device is a gamma radiation sensor for gamma radiation therapy, e.g. gamma knife surgery/radiation therapy. In another embodiment, the device is a proton radiation sensor for proton radiation therapy, e.g. proton beam therapy. The device may also be a neutron radiation sensor for neutron radiation therapy, e.g. fast neutron beam therapy, or alternatively an alpha or beta particle radiation sensor for alpha or beta particle radiation therapy, e.g. alpha or beta particle radiation therapy.

In one embodiment, the device is a sensor or detector in space applications for detection direction or source or intensity or wavelengths of radiation of gamma radiation or direction or source or intensity of particle radiation.

The present method may further be used for monitoring counterfeit goods. In such case, a small device comprising a known compound of formula (I) as defined above is attached to a goods at its manufacturing site. Should there be suspicion of a counterfeit product being imported for example, the goods may be subject to gamma radiation for a pre-determined amount of time, and the resulting intensity of colour of the light measured. If such intensity of colour differs from what the manufacturer has indicated, it may be concluded that the product is counterfeit.

According to another aspect, there is provided a method for creating a radiation map within at least a part of a space, comprising
arranging sensor material comprising a material represented by formula (I) to cover at least a part of the space,
using the method defined above for determining an amount of radiation irradiated on the sensor materials, and
providing the radiation map within the space, based on the determined amounts of radiation on the sensor materials and their locations.

This method, which uses the above-defined material of formula (I) and the above-defined method for determining an amount of radiation irradiated on the sensor materials, thus allows to for example monitor a space used for irradiating other materials or devices. Indeed, it may be that in such a space, it is desired to direct radiation to a specific point or location. The present method would in such a case allow to monitor whether radiation is directed to a wrong direction from the radiation source, and/or how much of the radiation is scattered, reflected and/or transmitted. It may also be that the aim is to provide an even radiation within the whole space, in which case the present method may be used for monitoring that this is actually the case, and that not some area of the space receives less radiation.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Furthermore, the described features, structures, or characteristics may be combined in any suitable manner in one or more embodiments. In the description, numerous specific details are provided, such as examples of lengths, widths, shapes, etc., to provide a thorough understanding of embodiments of the invention.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, i.e. a singular form, throughout this document does not exclude a plurality.

In the following Experimental part, concrete examples of use of the material are given to further illustrate the invention.

### EXPERIMENTAL PART

### Example 1—Preparation of the Materials

The materials tested had the following formulas, indicated with Na, Br, K, Li, Rb and MT46in the following results:

Na: Na₈Al₆Si₆O₂₄(Cl,S)₂

Br: Na₈Al₆Si₆O₂₄(Br,S)₂

K: (K,Na)₈Al₆Si₆O₂₄(Cl,S)₂

Li: (Li,Na)₈Al₆Si₆O₂₄(Cl,S)₂

Rb: (Rb,Na)₈Al₆Si₆O₂₄(Cl,S)₂

MT46: LiNa₇Al₆Si₆O₂₄(Br,S)₂:Sr(7 wt-%)

During the synthesis of the materials, zeolite A was first dried at 500° C. for 1 h. Stoichiometric amounts of zeolite A, NaCl, RbCl, KCl, LiCl, NaBr, Na₂SO₄ and LiBr were used as the starting materials, depending on the material, as listed below. The dopants were added as bromide SrBr₂ when used. Table 1 shows the synthesis conditions of each sample.

The starting materials were as follows:
Na: zeolite A, NaCl, Na₂SO₄
Br: zeolite A, NaBr, Na₂SO₄
K: zeolite A, KCl, Na₂SO₄
Li: zeolite A, LiCl, NaCl, Na₂SO₄
Rb: zeolite A, RbCl, Na₂SO₄
MT46: zeolite A, NaBr, LiBr, Na₂SO₄ and SrBr₂

TABLE 1

| Sample | First heating | Second heating |
|---|---|---|
| Na:Na₈Al₆Si₆O₂₄(Cl,S)₂ | 850° C. in air | 850° C. in 12 vol-% |
| | for 2 hours | H₂ and 88 vol-% |
| | | N₂ for 2 hours |
| Br:Na₈Al₆Si₆O₂₄(Br,S)₂ | 850° C. in air | 850° C. in 12 vol-% |
| | for 2 hours | H₂ and 88 vol-% |
| | | N₂ for 2 hours |
| K:(K,Na)₈Al₆Si₆O₂₄(Cl,S)₂ | 850° C. in air | 850° C. in 12 vol-% |
| | for 2 hours | H₂ and 88 vol-% |
| | | N₂ for 2 hours |
| Li:(Li,Na)₈Al₆Si₆O₂₄(Cl,S)₂ | 850° C. in air | 850° C. in 12 vol-% |
| | for 2 hours | H₂ and 88 vol-% |
| | | N₂ for 2 hours |
| Rb:(Rb,Na)₈Al₆Si₆O₂₄(Cl,S)₂ | 850° C. in air | 850° C. in 12 vol-% |
| | for 2 hours | H₂ and 88 vol-% |
| | | N₂ for 2 hours |
| MT46:LiNa₇Al₆Si₆O₂₄(Br,S)₂:Sr | 800° C. in air | 850° C. in 12 vol-% |
| (7 wt-%) | for 5 hours | H₂ and 88 vol-% |
| | | N₂ for 2 hours |

The materials were then each suspended separately in a tape-cast polymer matrix comprising ethanol Aa (15 weight-%), ethyl methyl ketone (=2-butanone, 30 weight-%), 2-[4-(2,4,4-trimethylpentan-2-yl)phenoxy]ethanol (sold under tradename Triton X-100, 2 weight-%), benzyl butyl phthalate (BBP, 6 weight-%) and polyvinyl butyral (PVB, 7 weight-%), the amount of the material prepared above being 40 weight-%. The mixture was then cast onto a polyester projector transparency, with a wet thickness of 300 μm. The resulting plates were then exposed to radiation as described below.

In addition to the above materials, also a Dürr intraoral CR imaging plate size 2 was tested (denoted “Dürr” below).

### 2. Exposure to Gamma Radiation

The plates were subjected to radiation using a ⁶⁰Co source which emits gamma rays at 1.1732 and 1.3325 MeV (average 1.250 MeV). The method used for ensuring the radiation quality was ISO 4037-1:2019, the conversion coefficients were as in ISO 4037-3:2019 and the uncertainty (k=2 in accordance with reference JCGM 100:2008) was 2.3 %. The irradiation was carried out in ambient air pressure, at a temperature of 20-22° and at 40-60% relative humidity.

In the following description the term “analysing the sample plates” corresponds to measuring the reflectance spectra and L*, a* and b* colour coordinates of the samples with a Konica Minolta CM-2300d handheld spectrometer and reading the contents of the plate with a Dürr VistaScan Mini View imaging plate reader. The samples were also measured before the exposure, in order to subtract a reference value from the obtained signals that were measured after the exposure.

First, a set of Na, Br, K, Li and Rb plates prepared as above was subjected to an air kerma value of 30 mGy at a distance of 293 cm from the radiation source for 34 s and analysed within 5 minutes after the exposure. Another set of Na, Br, K, Li and Rb samples was subjected to an air kerma value of 30 cGy at a distance of 293 cm for 338 s and analysed within 5 minutes after the exposure. Finally, yet another set of Na, Br, K, Li and Rb samples were subjected to 1.0 Gy at a distance of 78 cm for 77 s, and analysed within 5 minutes after the exposure.

In addition to these exposures, five other sets of Na, Br, K, Li and Rb samples were subjected to radiation, as well as additional MT46 and Dürr samples. These samples were kept at distances 1, 2, 3, 4 and 5, i.e. 51.5, 60.6, 78.0, 134 and 293 cm from the radiation source for 64 h. These distances correspond to air kerma values of 7000, 5000, 3000, 1000 and 204 Gy, respectively.

After the exposure, the plates were kept in darkness for 2 h after the exposure had ended, with only faint exit lights being illuminated near the ceiling. After 2 h the samples were analysed. The exposure conditions are listed in Table 8. The reference value was subtracted from the measured value, resulting in spectra as illustrated in FIGS. 2-6 and Table 8, and discussed below.

### 3. Exposure to Alpha Radiation

Two samples of Na₈Al₆Si₆O24(Cl,S)₂ were also subjected to alpha radiation using a ²⁴¹Am source which emits alpha and gamma rays with 59.5 keV energy, an air kerma rate of 0.011 mGy/h, an air kerma of 4.488 mGy, for a duration of 17 hours. The samples were placed at 1 cm from the radiation source, and the reference sample was kept behind lead blocks.

The samples were subjected to the radiation both using an aluminium filter (which blocks alpha radiation but does not block gamma radiation) and without (i.e. the samples were subjected to both alpha and gamma radiation).

### Results

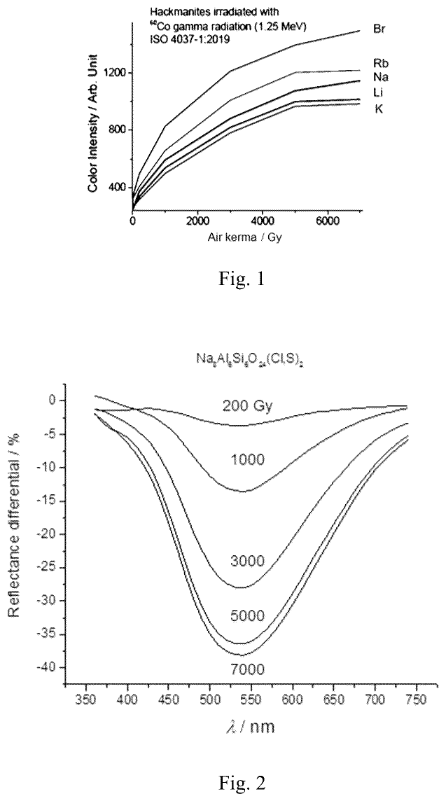

FIG. 1 illustrates colour intensity (in arbitrary units) of reflected light versus gamma radiation air kerma values (in Gy) from samples plates exposed to gamma radiation. The uppermost curve is for the sample Br, the second from top for Rb, the middle for Na, the fourth from top for Li and the lowermost for K. As can be seen, the intensity of colour increases with increasing gamma radiation, and depending on the material, reach a plateau level during these experiments.

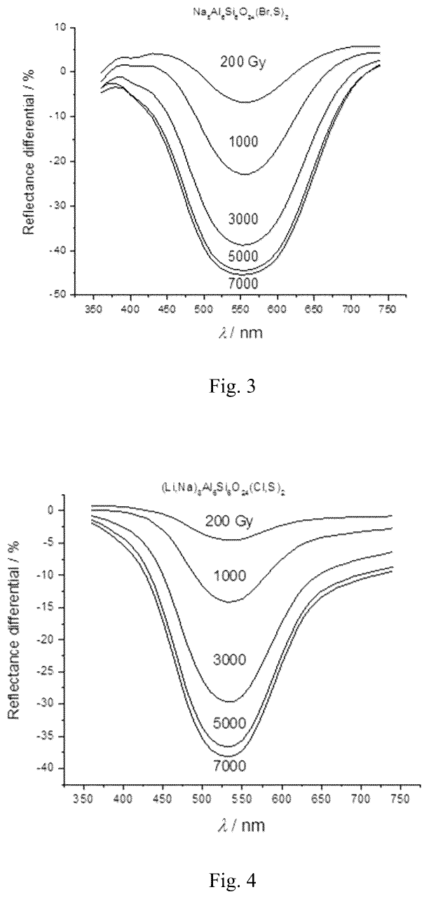

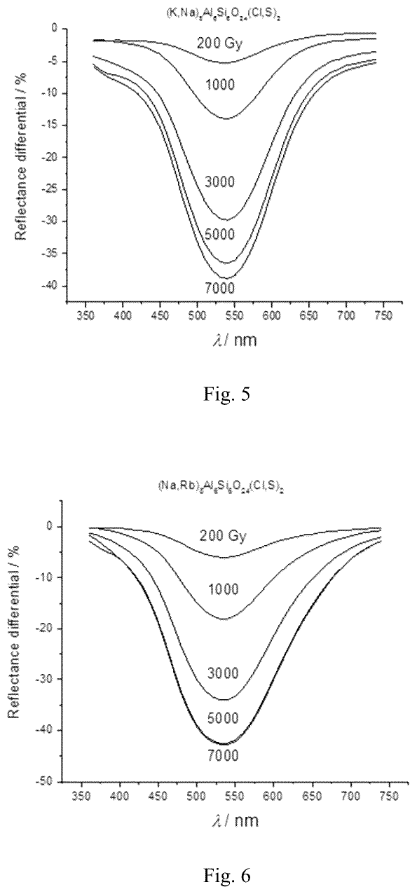

FIGS. 2-6 illustrate the reflectance differential in percentage (in ordinate) versus wavelength in nanometres (in abscissa) for plates exposed to 30 mGy gamma radiation (same plates as in FIG. 1). FIG. 2 if for the sample Na, FIG. 3 for Br, FIG. 4 for Li, FIG. 5 for K and FIG. 6 for Rb. In each Figure, the uppermost curve is the result of the sample with 200 Gy air kerma value, the second from top 1000 Gy air kerma value, the third (i.e. middle) 3000 Gy air kerma value, the fourth from top 5000 Gy air kerma value and the lowermost 7000 Gy air kerma values. In FIG. 6 the two lowermost curves are practically overlapping.

FIGS. 2-6 clearly show that the intensity of the colour increases with increasing radiation. Thus, it is possible to provide a database with measurement values for given amounts of radiation, which allows to measure the amount of radiation a sensor material has been subjected to.

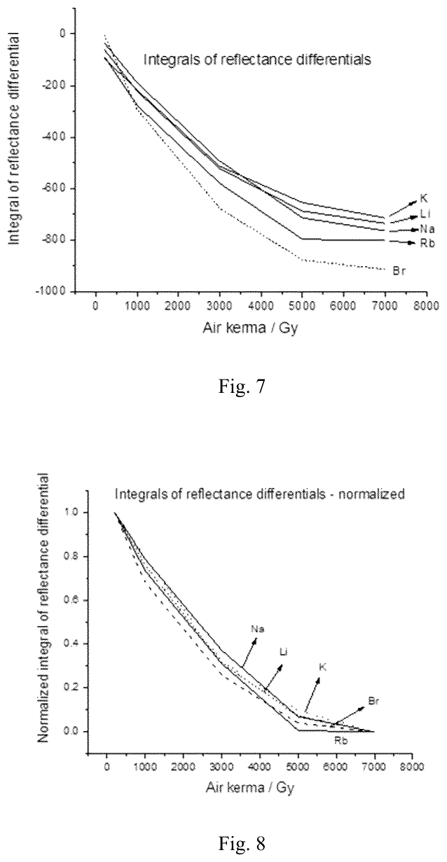

FIG. 7 shows the integrals of reflectance differentials (in ordinate) versus air kerma (in Gy, in abscissa), and FIG. 8 the same results normalised, for the same plates as the results in FIGS. 2-6. In FIG. 7, looking at the curves at the right-hand end of them (air kerma 7000 Gy), the uppermost is that for the sample K, the second from top Li, the middle one Na, the fourth from top Rb and the lowermost Br. Once the integrals of reflectance differentials are normalised (FIG. 8), all the curves have approximately the same shape.

The CIE L*a*b coordinates, which expresses colour as three values: L* for perceptual lightness, and a* and b* for the four unique colours of human vision (red, green, blue, and yellow), were obtained from the same measurements as the spectra shown in FIGS. 1-5, and are given below in Tables 2-6.

TABLE 2

| Na sample | 204 Gy | 1000 Gy | 3000 Gy | 5000 Gy | 7000 Gy |
|---|---|---|---|---|---|
| L* | −1.56 | −6.01 | −14.14 | −20.26 | −21.65 |
| a* | 1.4 | 5.73 | 12.71 | 16.87 | 17.6 |
| b* | −1.18 | −6.06 | −12.91 | −17.28 | −17.84 |

TABLE 3

| Br sample | 204 Gy | 1000 Gy | 3000 Gy | 5000 Gy | 7000 Gy |
|---|---|---|---|---|---|
| L* | −1.15 | −9.97 | −22.91 | −30 | −31.58 |
| a* | 2.71 | 9.83 | 19.82 | 24.78 | 25.83 |
| b* | −3.51 | −13.94 | −26.55 | −31.76 | −32.76 |

TABLE 4

| Li sample | 204 Gy | 1000 Gy | 3000 Gy | 5000 Gy | 7000 Gy |
|---|---|---|---|---|---|
| L* | −1.83 | −6.19 | −14.94 | −19.97 | −21.3 |
| a* | 2.39 | 7.53 | 17.42 | 22.82 | 23.8 |
| b* | −2.33 | −6.66 | −13.34 | −15.68 | −15.8 |

TABLE 5

| K sample | 204 Gy | 1000 Gy | 3000 Gy | 5000 Gy | 7000 Gy |
|---|---|---|---|---|---|
| L* | −2 | −5.45 | −13.21 | −17.25 | −18.86 |
| a* | 2.05 | 6.34 | 14.46 | 18.65 | 19.93 |
| b* | −1.32 | −5.17 | −11.45 | −14.93 | −15.85 |

TABLE 6

| Rb sample | 204 Gy | 1000 Gy | 3000 Gy | 5000 Gy | 7000 Gy |
|---|---|---|---|---|---|
| L* | −2.42 | −7.9 | −17.28 | −24.27 | −24.56 |
| a* | 2.85 | 9.24 | 19.44 | 25.44 | 25.59 |
| b* | −2.5 | −7.85 | −15.87 | −20.54 | −20.66 |

These coordinates are another way of quantifying the intensity of the colour and can also be used in the present method for determining the amount of radiation received by a sensor material.

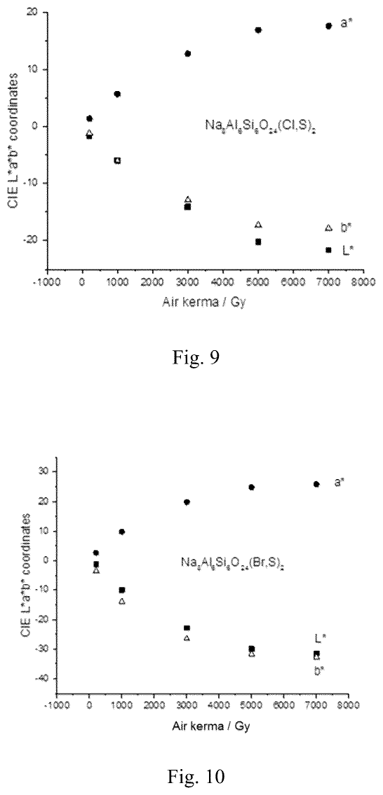

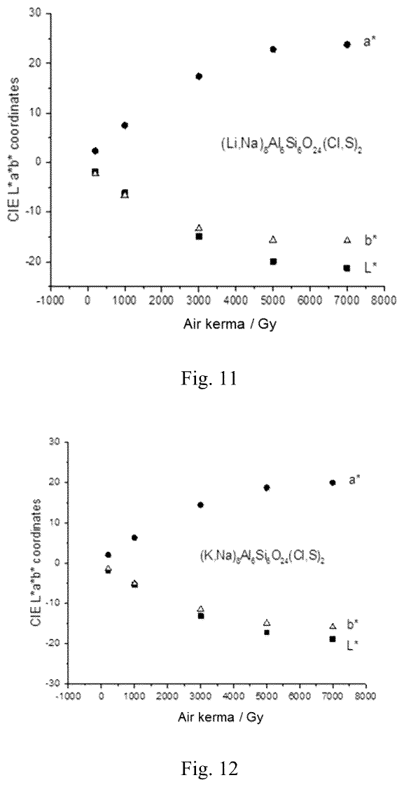

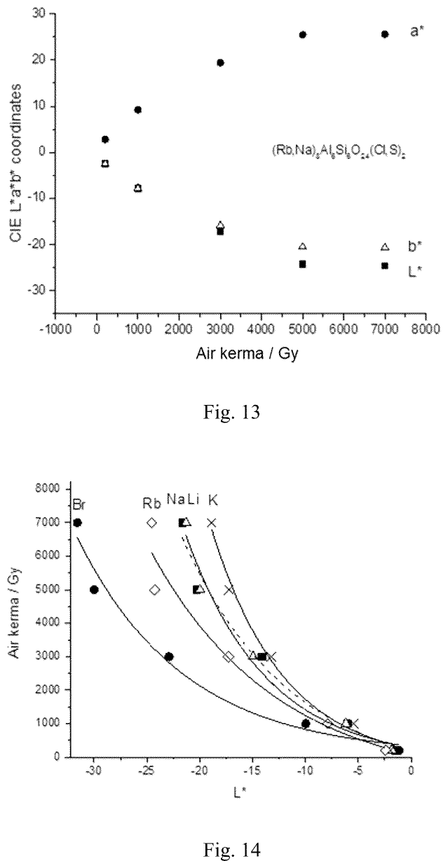

The coordinates are also shown in FIGS. 9-13, with the coordinates in ordinate and the air kerma (in Gy) in abscissa. In each figure, the squares denote the coordinate L*, the rounds the coordinate a* and the triangles the coordinate b*. FIG. 9 shows the results for the sample Na, FIG. 10 for Br, FIG. 11 for Li, FIG. 12 for K and FIG. 13 for Rb.

The air kerma (in Gy) can be obtained from the detected L* value through an exponential correlation between air kerma and L*:

$$Air kerma = A + B \times e ( C \times L \text{*)}$$

Table 7 gives the values of A, B and C for the tested materials, obtained by fitting the experimental air kerma vs. L* curves to the equation given above using OriginLab Origin 2016 software.

TABLE 7

| Material | A | B | C |
|---|---|---|---|
| Na | −639.5 | 842.8 | −0.099 |
| Li | −127.8 | 416.8 | −0.131 |
| K | −195.9 | 445.8 | −0.146 |
| Rb | −820 | 897.6 | −0.083 |
| Br | 53.6 | 289.6 | −0.099 |

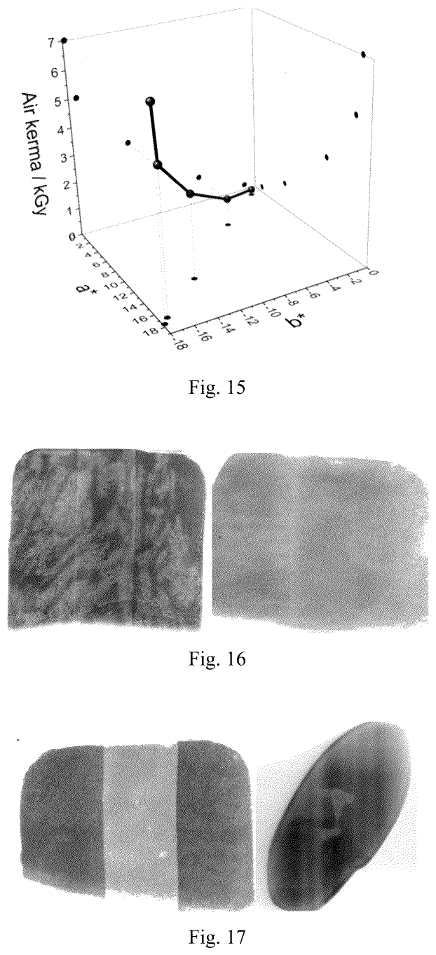

FIG. 14 illustrates the L* value of the tested materials (Na, Li, K, Rb and Br) as a function of the air kerma (in Gy). The spheres denote the sample Br, the open squares Rb, the black squares Na, the triangles Li and the crosses K. FIG. 15 illustrates the a* and b* coordinates as a function of the air kerma (in kGy).

The plates were also assessed after exposure to determine whether an image had been formed or not. The assessment was carried out with a commercial CR plate reader from Dürr Dental. The results are given below in Table 8. Samples subjected to 0.030, 0.30 and 1.0 Gy air kerma values were analysed 1 minute after the corresponding exposure sequence had ended, and samples subjected to 204, 1000, 3000, 5000 and 7000 Gy were analysed 2-3 h after the 64 h exposure had ended.

TABLE 8

| | Distance | | | Air kerma | | |
|---|---|---|---|---|---|---|
| | from the | Exposure | | rate | Air kerma | |
| Sample | source | time | | (Gy/h) | (Gy) | Image |
| Na | 5 = 293 cm | 34 | s | 3.19 | 0.030 | No |
| Br | | | | | | No |
| K | | | | | | No |
| Li | | | | | | No |
| Rb | | | | | | No |
| Na | 1 = 51.5 cm | 64 | h | 109 | 7 000 | Yes |
| Br | | | | | | Yes |
| K | | | | | | No |
| Li | | | | | | Yes |
| Rb | | | | | | Yes |
| MT46 | | | | | | Yes |
| Dürr | | | | | | Yes |
| Na | 2 = 60.6 cm | 64 | h | 78.1 | 5 000 | Yes |
| Br | | | | | | Yes |
| K | | | | | | No |
| Li | | | | | | Yes |
| Rb | | | | | | Yes |
| Na | 3 = 78.0 cm | 64 | h | 46.9 | 3 000 | Yes |
| Br | | | | | | Yes |
| K | | | | | | No |
| Li | | | | | | Yes |
| Rb | | | | | | No |
| Na | 4 = 134 cm | 64 | h | 15.6 | 1 000 | Yes |
| Br | | | | | | Yes |
| K | | | | | | No |
| Li | | | | | | Yes |
| Rb | | | | | | No |
| Na | 5 = 293 cm | 64 | h | 3.19 | 204 | No |
| Br | | | | | | No |
| K | | | | | | No |
| Li | | | | | | No |
| Rb | | | | | | No |
| Na | 5 = 293 cm | 338 | s | 3.19 | 0.30 | No |
| Br | | | | | | No |
| K | | | | | | No |
| Li | | | | | | No |
| Rb | | | | | | No |
| Na | 3 = 78.0 cm | 77 | s | 46.9 | 1.0 | Yes |
| Br | | | | | | No |
| K | | | | | | No |
| Li | | | | | | No |
| Rb | | | | | | No |

The results of Table 8 show that the prepared hackmanite materials surprisingly exhibit imaging plate properties spanning from air kerma values of as low as 1.0 to 7000 Gy.

FIGS. 16 and 17 illustrate some samples after gamma radiation, i.e. proofs of images having been formed on the samples. In FIG. 16, the photo on the left is of the Br sample at a distance of 51.5 cm from the source (air kerma 7000 Gy), two hours after exposure. The photo on the right is of the Li sample at a distance of 78.0 cm from the source (air kerma 3000 Gy), also two hours after exposure. In FIG. 17, on the left is the sample Na, at a distance of 293 cm from the source (air kerma 1 Gy) and taken one minute after exposure, while on the right is the sample MT46, at a distance of 51.5 cm (air kerma 7000 Gy), measured three hours after exposure.

The samples radiated with both alpha and gamma radiation were measured for their colour intensity from reflectance spectra analysed with an Avantes AvaSpec HS-TEC using an Ocean Optics LS-1-Cal as the light source providing a continuous spectrum. The results are shown in Table 9.

TABLE 9

| Sample | Radiation | Colour intensity |
|---|---|---|
| Reference | none | 13.2 |
| Na13 | gamma | 119.3 |
| Na14 | gamma and alpha | 368.8 |

The colour intensity (in arbitrary units) was clearly higher when the samples were subjected to both alpha and gamma radiation, indicating that also alpha radiation causes coloration of materials of formula (I).

1. A method for determining an amount of radiation having a wavelength of 1 zm-10 pm or particle radiation irradiated on a sensor material, the method comprising:
exposing the sensor material to said radiation having a wavelength of 1 zm-10 pm or particle radiation for a period of time,
subjecting the exposed sensor material to a measurement by a device configured to measure intensity of a colour,
measuring the intensity of the colour of reflected, transmitted or detected light, and
determining the amount of radiation to which the sensor material has been exposed, based on the measured intensity of the colour of the reflected, transmitted or detected light,
wherein the sensor material comprises a material represented by formula (I)
(M′)₈(M″M″′)₆O₂₄(X,X′)₂:M″″ formula (I)
wherein
M′ represents calcium or a monoatomic cation of an alkali metal selected from Group 1 of the IUPAC periodic table of the elements, or any combination of such cations;
M″ represents a trivalent monoatomic cation of an element selected from Group 13 of the IUPAC periodic table of the elements, or of a transition element selected from any of Groups 3-12 of the IUPAC periodic table of the elements, or any combination of such cations;
M′″ represents a monoatomic cation of an element selected from Group 14 of the IUPAC periodic table of the elements, or of an element selected from any of Groups 13 and 15 of the IUPAC periodic table of the elements, or of Zn, or any combination of such cations;
X represents an anion of an element selected from Group 17 of the IUPAC periodic table of the elements, or any combination of such anions, or wherein X is absent;
X′ represents an anion of one or more elements selected from Group 16 of the IUPAC periodic table of the elements, or any combination of such anions, or wherein X′ is absent; and
M″″ represents a dopant cation of an element selected from rare earth metals of the IUPAC periodic table of the elements, or from transition metals of the IUPAC periodic table of the elements, or of Ca, Ba, Sr, TI, Pb, or Bi, or any combination of such cations, or wherein M″″ is absent;
with the proviso that at least one of X and X′ is present.

2. The method according to claim 1, wherein the determining the amount of radiation to which the sensor material has been exposed is carried out by comparing the measured intensity of the colour of the reflected, transmitted or detected light to a database comprising measured intensity values and corresponding radiation values.

3. The method according to claim 2, wherein the database comprises at least one of a lookup table and a graph.

4. The method according to claim 1, wherein the period of time the sensor material is exposed to radiation is up to ten years.

5. The method according to claim 1, wherein the radiation is gamma radiation.

6. The method according to claim 1, wherein the device configured to measure intensity of a colour is selected from a the group consisting of a colour spectrophotometer, a photodetector, and a camera.

7. The method according to claim 1, wherein M′ represents a monoatomic cation of an alkali metal selected from Group 1 of the IUPAC periodic table of the elements, or any combination of such cations, with the proviso that M′ does not represent the monoatomic cation of Na alone.

8. The method according to claim 1, wherein M′ represents a combination of at least two monoatomic cations of different alkali metals selected from the group consisting of Li, Na, K, Rb, Cs, and Fr.

9. The method according to claim 1, wherein M″ represents a trivalent monoatomic cation of a metal selected from a the group consisting of Al and Ga, or a combination of such cations.

10. The method according to claim 1, wherein M″ represents a trivalent monoatomic cation of B.

11. The method according to claim 1, wherein M″′ represents a monoatomic cation of an element selected from the group consisting of Si and Ge, and a combination of such cations.

12. The method according to claim 1, wherein M″′ represents a monoatomic cation of an element selected from the group consisting of Al, Ga, N, P, As, and any combination of such cations.

13. The method according to claim 1, wherein X represents an anion of an element selected from the group consisting of F, Cl, Br, I, At, and any combination of such anions.

14. The method according to claim 1, wherein X′ represents a monoatomic or a polyatomic anion of one or more elements selected from the group consisting of O, S, Se, Te, and any combination of such anions.

15. The method according to claim 1, wherein M″″ represents a cation of an element selected from the group consisting of Yb, Er, Tb, and Eu, and any combination of such cations.

16. The method according to claim 1, wherein M″″ represents a cation of an element selected from the group consisting of Ti, V, Cr, Mn, Fe, Co, Ni, Cu, Ag, W, and Zn, or any combination of such cations.

17. The method according to claim 1, further comprising arranging the sensor material in a polymer matrix.

18. A method for creating a radiation map within at least a part of a space, comprising
arranging the sensor material comprising the material represented by formula (I) as defined in claim 1, to cover at least a part of the space,
using the method according to claim 1 for determining an amount of radiation irradiated on the sensor material, and
providing the radiation map within the space, based on the determined amount of radiation on the sensor material and its location.

19. A method for imaging with gamma radiation comprising:
exposing a substrate comprising the sensor material as defined in claim 1 to gamma radiation;
subjecting the exposed sensor material to a measurement by a device configured to measure intensity of a colour; and
generating an image from the measured intensity.

20. A dosimeter for gamma irradiation, comprising the material represented by formula (I) of claim 1.
